(19) United States
(12) Patent Application Publication
(10) Pub. No.: US 2011/0054801 A1
(43) Pub. Date: Mar. 3, 2011

(54) Detecting a Chemical Impurity

(75) Inventors: Victoria Hilborne, London (GB); John King, London (GB); Roger Brown, London (GB)

(73) Assignee: SOUTH BANK UNIVERSITY ENTERPRISES LIMITED, London (GB)

(21) Appl. No.: 12/160,607

(22) PCT Filed: Jan. 12, 2007
(86) PCT No.: PCT/GB07/00093

§ 371 Date: Aug. 21, 2010

(30) Foreign Application Priority Data
Jan. 12, 2006 (GB) 0600528.4

(51) Int. Cl. G06F 19/00

(52) U.S. Cl. 702/22

(57) ABSTRACT

The invention is a detector (15) which comprises: a probe (17) insertable into a drink; processing means (13) coupled to the probe; and an indicator coupled to the processing means; wherein the processing means is configured to receive a signal from the probe and compare said received signal with a stored reference to determine whether a liquid into which said probe is inserted includes a chemical impurity, the processor being configured to operate said indicator in the event that said liquid is determined to include a said chemical impurity. The invention is also a method of detecting a chemical impurity in a liquid of a drink, the method comprising: inserting a probe (17) into the liquid; connecting the probe to a source of electric potential; measuring a response of said liquid; comparing said response to a reference; determining whether a liquid into which said probe is inserted includes a chemical impurity; and indicating that said liquid includes a said chemical impurity.

The present invention relates to a method and device for detecting a drug or other chemical impurity in a drink.

It is a known illicit practice for drugs or other chemical impurities to be introduced to a person's drink in a bar or club, without their knowledge to facilitate an assault or robbery. This practice is referred to colloquially as “spiking”. In the present application, the term “chemical impurity” means any substance, including a drug, which can be introduced to a drink and which has a detrimental pharmacological effect on the consumer, above and beyond the effect of any normal content of the drink, such as its alcohol content. Known drugs allegedly used for such illicit practices include Ketamine hydrochloride, Gamma-Hydroxybutyric Acid (GHB) and some benzodiazepines such as Flunitrazepam (Rohypnol®).

Ketamine, GHB and benzodiazepines are all drugs that can depress the central nervous system, depending on dosage. Without alteration, these drugs are colourless, odourless and flavourless in aqueous solution and therefore are not visible to the consumer once introduced to a drink. Rohypnol is illegal in the US, and prescription only in the UK, and is typically altered during manufacture by the incorporation of a blue dye to reduce the possibility of it being misused for spiking, as the blue dye is visible in solution. Ketamine hydrochloride is in the same family of drugs as PCP (phencyclidine). When used in humans in sufficient dosages the drug acts as a dissociative anaesthesia. Benzodiazepine is a sedative which has an amnesiac effect post incident. GHB has become popular for recreational use in clubs, with users enjoying an alcohol-like high. Chemical analogues of GHB which are converted to GHB in the body such as gamma butyrylactone and 1,4-butanediol have also been proposed or used. GHB and its chemical analogues can have sedative and amnesiac effects, although unlike the other drugs referenced herein, GHB is produced naturally by the body in small amounts.

US Patent Application US20010046710A1 has proposed a method for detecting GHB using a small piece of paper (test strip) or such, on which there is a solution which responds chemically by changing colour in the presence of illicitly manufactured GHB. A known illicit method of manufacturing GHB comprises mixing sodium hydroxide with GammaButyrolactone. This method produces the sodium salt of GHB (Na-GHB) and if the method is performed inaccurately, as is generally the case during illicit manufacture, residual sodium hydroxide remains. The prior art detection method does not detect GHB but instead detects the presence of an alkali (i.e. sodium hydroxide) in the illicitly manufactured substance. Since the amount of NaOH present in GHB may not be consistent and pure GHB does not contain NaOH, the prior art method of detection is unreliable.

In addition the prior art method requires the consumer to carry out a relatively intricate test of a drink sample and to interpret the result in accordance with a colour change which can be subjective. The test can easily give false readings because it may be carried out inaccurately or because the result may be misinterpreted because of inadequate ambient lighting to enable proper interpretation of the result. The prior art method is relatively time consuming, difficult to carry out unobtrusively, and can be expensive as it may require many test strips to be used over the course of an evening. The method further suffers from the disadvantage that the test strips are pre-prepared and used for testing all types of drinks in all ambient conditions. No measurement of the actual unadulterated drink that is served is carried out on which to base a comparison when a drink is subsequently tested for spiking. Therefore, in the prior art, testing is carried out on a drink sample based on fixed absolute terms according to a predetermined characteristic of a standard drink, rather than relative to a measurement of an actual drink purchased.

The present invention provides an alternative method of detecting a chemical impurity in a drink.

The present invention provides a detector comprising: a probe insertable into a drink; processing means coupled to the probe; and an indicator coupled to the processing means; wherein the processing means is configured to receive a signal from the probe and compare said received signal with a stored reference to determine whether a liquid into which said probe is inserted includes a chemical impurity, the processor being configured to operate said indicator in the event that said liquid is determined to include a said chemical impurity.

The invention also provides a method of detecting a chemical impurity in a liquid of a drink, the method comprising: inserting a probe into the liquid; connecting the probe to a source of electric potential; measuring a response of said liquid; comparing said response to a reference; determining whether a liquid into which said probe is inserted includes a chemical impurity; and indicating that said liquid includes a said chemical impurity.

In order that the present invention may be well understood, some embodiments thereof, which are given by way of example only, will now be described with reference to the accompanying drawings, in which:

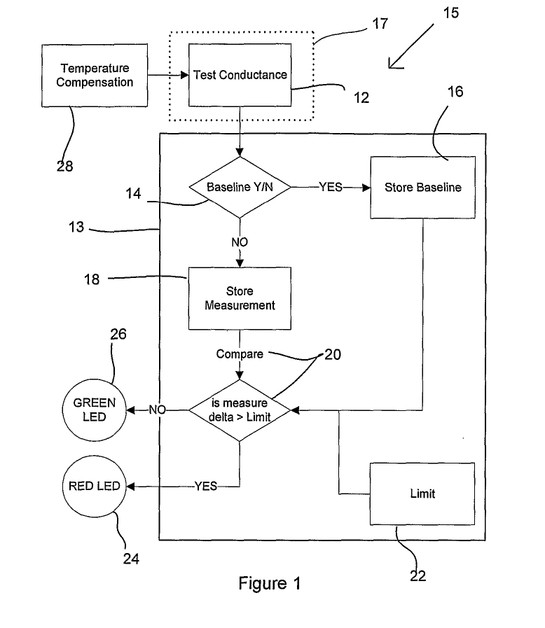

FIG. 1 is a flow diagram showing the functionality of a detector;

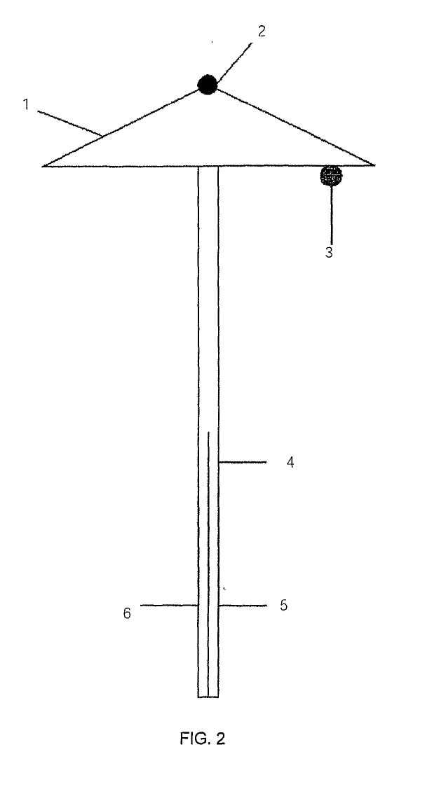

FIG. 2 is a side view of a detector;

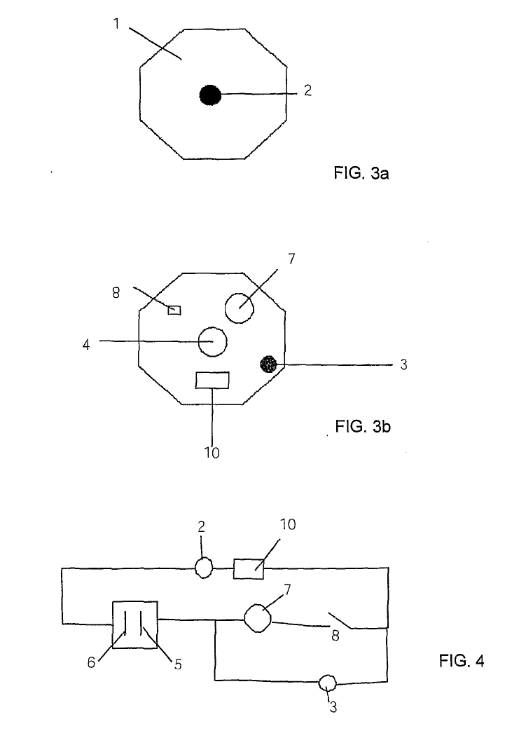

FIG. 3a is a top view of the detector shown in FIG. 2;

FIG. 3b is a bottom view of the detector;

FIG. 4 is a circuit diagram showing the electronics of the detector;

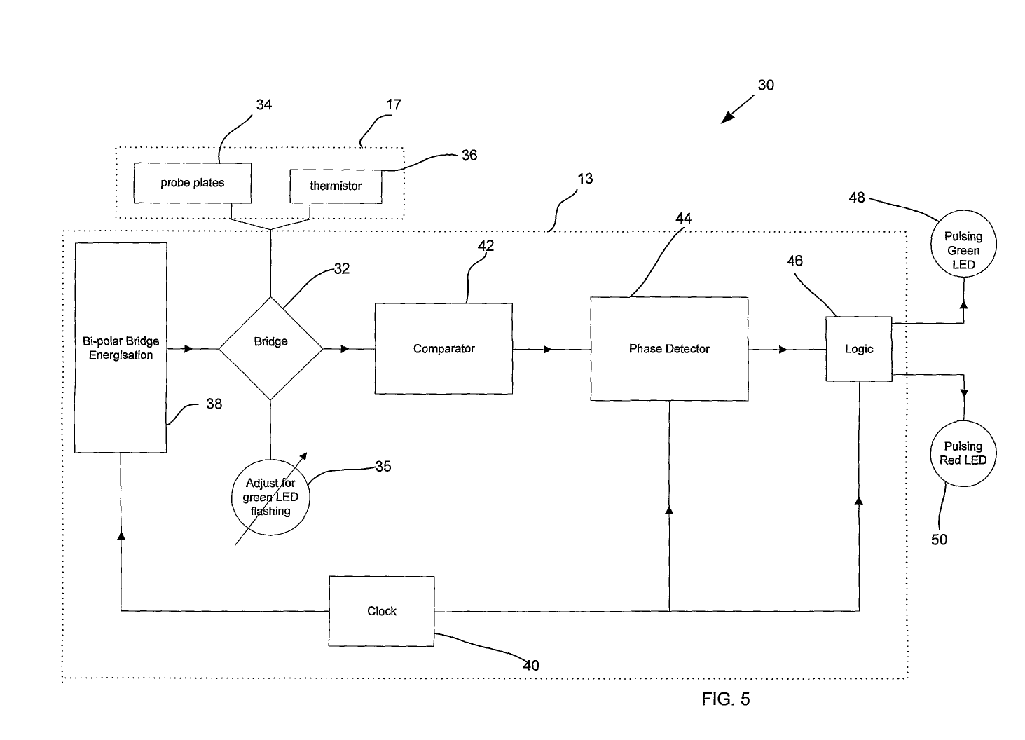

FIG. 5 is a flow diagram showing the functionality of another arrangement of the electronics of the detector; and

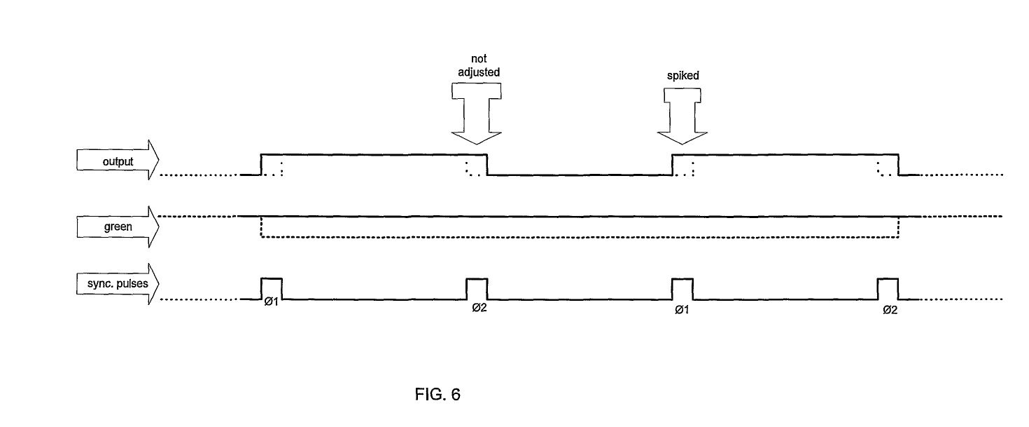

FIG. 6 is a phase diagram showing the detector in operation.

It is not hereto recognised that the chemical impurity GHB, for example, is ionic in aqueous solution and its constituent ions are capable of carrying electrical charge. The following simplified equation shows that on introduction to an aqueous liquid such as a beverage, GHB forms a short chain organic anion and a hydrogen proton cation.

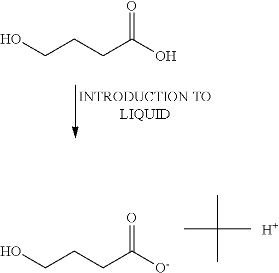

The hydrogen proton cation is an electrical charge carrier. The introduction of GHB to an aqueous liquid increases the conductivity of the liquid. The increase in conductivity is generally proportional to the quantity of GHB introduced and therefore the increase in conductivity is a good measure of the amount of GHB added. The sodium salt of GHB (Na-GHB) is often used in spiking. In Na-GHB, Na⁺ is formed on introduction to aqueous solution, instead of H. Such Na⁺ ions are also electrical charge carriers and therefore introduction of Na-GHB to a liquid also increases the conductivity of the liquid.

Aqueous solutions such as alcoholic and non-alcoholic drinks are to some extent ionic and therefore conduct electricity. The conductivity of the drink depends on the particular type of beverage, and further details on the range of baseline conductivities of different drinks are provided below. “Baseline conductivity” in this context means the conductivity of a drink which is in unadulterated form without the introduction of a chemical impurity. Since the baseline conductivity of a drink can be measured, the amount of GHB added to a drink can be measured according to the increase in conductivity as compared to the baseline.

In situ measurement of a baseline conductivity of a drink at the point of sale is inherently more accurate as a means of comparison than in the prior art method described above in which a baseline characteristic is predetermined by the test strip manufacturer for all possible drinks and in all ambient conditions. The baseline conductivity of certain drinks may vary from time to time or from venue to venue. Also, water does not have a consistent conductivity because its conductivity is dependent on the level of impurities, i.e. conductivity is dependent on if the water is soft or hard. Accordingly, a drink served with soft water has a different baseline conductivity than a drink served with hard water, although the variation in conductivity for each type of drink (e.g. red wine, white wine) is more significant. The temperature of a drink also affects conductivity, and a warm drink may be more conductive than a cold drink. It will be appreciated therefore that the prior art method of detection involving a predetermined characteristic of a drink is less accurate than embodiments of the present invention, since that predetermined characteristic may not accurately represent the state of a drink at the point of sale. Therefore, real time measurement of a drink is preferable.

In accordance with embodiments of the present invention, a conductivity of a drink is measured at the point of sale or shortly thereafter thereby achieving an accurate baseline conductivity. The conductivity of the drink can then be measured periodically after purchase, and the subsequent conductivity measurements are compared to the previously measured baseline so that if the change in conductivity exceeds a threshold it can be determined that a drink has been spiked. The baseline conductivity can be measured (automatically or manually) by inserting a probe into a drink. The detector stores the baseline, until reset, so that subsequent conductivity measurements can be compared to the baseline. Such a detector according to embodiments of the invention can be left in situ so that the conductivity can be continually monitored and if a chemical impurity is added to the drink the conductivity increases a predetermined amount above the baseline, the device provides an indication to the consumer that the drink may have been spiked. Alternatively, the device can be introduced to the drink periodically so that measurements can be taken and compared to the baseline stored in the device.

The table below shows in more detail the relationship between conductivity of different alcoholic drinks (mScm⁻¹) and the concentration of GHB (mgcm⁻³) for a range of temperatures (degrees centigrade).

TABLE

| | | | 5° C. | 10° C. | 15° C. | 22° C. |
|---|---|---|---|---|---|---|
| Alcoholic Drink | GHB | | mScm⁻¹ | mScm⁻¹ | mScm⁻¹ | mScm⁻¹ |
| Bacardi Breezer | 0 | mgcm⁻³ | 0.786 | 0.893 | 1.000 | |
| Orange | 0.5 | mgcm⁻³ | 0.821 | 0.946 | 1.071 | |
| | 1 | mgcm⁻³ | 0.929 | 1.071 | 1.214 | |
| | 2 | mgcm⁻³ | 1.071 | 1.250 | 1.464 | |
| | 4 | mgcm⁻³ | 1.464 | 1.714 | 1.964 | |
| White Wine | 0 | mgcm⁻³ | 0.643 | 0.821 | | |
| | 0.5 | mgcm⁻³ | 0.857 | 0.964 | | |
| | 1 | mgcm⁻³ | 0.929 | 1.179 | | |
| | 2 | mgcm⁻³ | 0.964 | 1.179 | | |
| | 4 | mgcm⁻³ | 1.250 | 1.429 | | |
| Red Wine | 0 | mgcm⁻³ | | | | 1.643 |
| | 0.5 | mgcm⁻³ | | | | 2.071 |
| | 1 | mgcm⁻³ | | | | 2.179 |
| | 2 | mgcm⁻³ | | | | 2.429 |
| | 4 | mgcm⁻³ | | | | 2.786 |
| Lager | 0 | mgcm⁻³ | 1.157 | 1.193 | 1.357 | |
| | 0.5 | mgcm⁻³ | 1.25 | 1.357 | 1.43 | |
| | 1 | mgcm⁻³ | 1.34 | 1.368 | 1.536 | |
| | 2 | mgcm⁻³ | 1.536 | 1.571 | 1.786 | |
| | 4 | mgcm⁻³ | 1.953 | 2.014 | 2.289 | |
| Bacardi Breezer | 0 | mgcm⁻³ | 0.51 | 0.587 | 0.68 | 0.786 |
| Lime | 0.5 | mgcm⁻³ | 0.536 | 0.672 | 0.737 | |
| | 1 | mgcm⁻³ | 0.59 | 0.698 | 0.814 | |
| | 2 | mgcm⁻³ | 0.741 | 0.861 | 1.01 | |
| | 4 | mgcm⁻³ | 1.044 | 1.233 | 1.448 | 1.714 |
| Bacardi Breezer | 0 | mgcm⁻³ | | | | 0.555 |
| Crisp Apple | 0.5 | mgcm⁻³ | | | | 0.590 |
| | 1 | mgcm⁻³ | | | | 1.067 |
| | 2 | mgcm⁻³ | | | | 1.36 |
| | 4 | mgcm⁻³ | | | | 1.73 |
| Bacardi Breezer | 0 | mgcm⁻³ | | | | 0.464 |
| Watermelon | 0.5 | mgcm⁻³ | | | | 0.571 |
| | 1 | mgcm⁻³ | | | | 0.714 |
| | 2 | mgcm⁻³ | | | | 1.179 |
| | 4 | mgcm⁻³ | | | | 1.607 |
| Smirnoff Ice Lemon | 0 | mgcm⁻³ | | | | 0.714 |
| | 0.5 | mgcm⁻³ | | | | 0.821 |
| | 1 | mgcm⁻³ | | | | 0.893 |
| | 2 | mgcm⁻³ | | | | 1.107 |
| | 4 | mgcm⁻³ | | | | 1.786 |
| Archers Schnapps | 0 | mgcm⁻³ | | | | 0.446 |
| Aqua Peach | 0.5 | mgcm⁻³ | | | | 0.482 |
| | 1 | mgcm⁻³ | | | | |
| | 2 | mgcm⁻³ | | | | 0.714 |
| | 4 | mgcm⁻³ | | | | 1.304 |

In the table all conductivity values are an average of 3 measurements with a difference of <0.036 mScm⁻¹.

The following graph shows the generally linear relationship between concentration of GHB-Na and conductivity in a drink.

The typical temperature of drinks served from chilling cabinets in pubs, bars and clubs is 7° C. The temperature of a drink may rise after serving to ambient temperature, which may be a change of 10° C. or more. When served with ice, a drink initially reduces and then rises in temperature.

The typical dosage of GHB used in spiking is about 4-8 mgcm⁻³, which is sufficient to achieve a detrimental pharmacological effect on the consumer. It will be seen from the above data that the conductivity of a drink increases as compared with an adulterated drink. More specifically, the conductivity approximately doubles with the introduction of a typical spiking dosage of 4 mgcm⁻³ of GHB, and in some cases the increase in conductivity is more than double as compared with an unadulterated drink.

Moreover the present invention recognises that when a probe is inserted into a drink and connected to a source of electrical potential there is a change in the liquid's response to the probe between a drink which has not been spiked and a drink which has been spiked. Measurement of that change in response can determine whether a drink has been spiked.

Embodiments of the invention measure a change in conductivity. As described herein, GHB in aqueous solution is ionic and separates to produce hydrogen protons (H⁺). Since hydrogen protons, or ions, are charge carriers, the introduction of GHB to a drink increases electrical conductivity. There are though additional methods of measuring the response of a liquid, including pH measurement. Accordingly, the present invention extends to a detector which detects the presence of chemical impurities in a drink by measurement of its pH.

The properties which can be utilised in the present invention include the conductivity or the pH of the drink. As explained in more detail below, embodiments of the invention may comprise an electrical circuit which incorporates an indicator and the indicator may be activated if the circuit is completed by a probe being immersed in a liquid with a conductivity or pH above a threshold level. The probe is set so that, in unadulterated drinks, the indicator is not activated; this can be done by setting a baseline threshold which is equivalent to the unadulterated drink conductivity or pH. The electrical components are connected by an electrical circuit which can be an integrated circuit on a chip and the baseline or threshold reading for an unadulterated drink stored by the chip. As the conductivity and pH of the drink can be affected by changes in temperature the chip can include a temperature compensatory system which measures the temperature and adjusts the baseline or threshold value accordingly.

The probe may have an anode and a cathode connected to a source of electric power such as a battery, although as explained below this is not currently preferred. In one embodiment there can be an anode and cathode which generate an electric field between them when placed in water and this avoids the need for any external power source. The anode and cathode can be of dissimilar metals which do not affect the taste or appearance of the drink. The change in conductivity can be marked and, for the addition of a commonly used amount of a drug, the change in conductivity will affect the current flowing and thus activate the indicator. A convenient indicator is a light such as a light emitting diode (LED), although other indicators such as a sound alarm etc. can be used. Preferably the circuit includes a controller which causes the LED to flash when activated. The probe can be attached to or incorporated in an object which acts as a carrier for the probe and which can be placed in a drink; such a carrier can be a straw or wooden stick e.g. a toothpick, drinks umbrella, cocktail stick holding an olive or cherry etc. The carrier is not critical provided it does not have an appreciable effect of the conductivity or pH of a liquid into which it is placed. When the object/carrier is in contact with an unadulterated drink a baseline current flows and the indicator is controlled so that it is not activated. When a drug is added to a drink the current flow increases and the indictor is then activated. Alternatively the object/carrier can be placed in a drink before it is consumed so that, if there were a drug present, the indicator would be activated. When an LED is used as the indicator, if the conductivity or pH of the liquid into which the probe is placed is increased by the addition of a drug, the LED will light up or begin flashing. When a straw, drinks umbrella, or a stick holding an olive or cherry is used a carrier the carrier can be left inconspicuously in the drink, so there would be an immediate indication if a drug were added to the drink. When the pH is the property used the device can include a conventional pH measuring circuit or system suitably adapted.

Referring now in more detail to embodiments of the invention, FIG. 1 is a flow diagram showing components of a detector 15 in a functional relationship.

The detector 15 comprises a probe 17 insertable into a drink. The probe is selectively connectable to a source of electric potential (not shown) such that a response of said liquid can be measured when the probe is connected to the source and a signal output from the probe corresponding to the response. For instance, the probe 17 may apply an electric field to the liquid and measure the liquid's response. In FIG. 1, the probe 17 comprises conductivity measuring means 12 for applying an electric field and measuring the conductivity of a drink into which the probe is inserted.

The conductivity measuring means 12 may take any suitable form, and one such form is described in more detail below with reference to FIG. 5.

Referring to FIG. 1, the conductivity measuring means 12 comprises two electrodes, or probe plates. An electrical field is generated between the electrodes causing migration of charge carriers and a current to flow. Accordingly, the resistance of the drink between the electrodes can be determined and hence the conductivity (i.e. the inverse of resistance).

The detector comprises processing means 13 coupled to the probe 17. The processing means is configured to receive a signal from the probe and compare said received signal with a stored reference to determine whether a liquid into which said probe is inserted includes a chemical impurity. The stored reference is a baseline which corresponds to a conductivity of the liquid when the liquid does not include a chemical impurity and the processor means 13 determines that the liquid includes a said chemical impurity when a change in the conductivity from the baseline exceeds a threshold.

The baseline can be measured in situ by measurement of the conductivity by the user preferably shortly after the point of sale or at a point when the consumer is confident that the drink does not include a chemical impurity. The detector 15 comprises input means 14 for receiving an input from the user. When the drink is first tested, the consumer provides an input to the detector that a baseline conductivity of a drink is being measured. Once measured, as shown in FIG. 1, the baseline can be stored in storage means 16 so that a subsequently measured conductivity of said liquid can be compared with the baseline.

The input means 14 may take any suitable form such as two buttons. A first button is used for inputting that a baseline measurement is to be taken and a second button is used for inputting that a measurement of the drink for testing is to be taken. Alternatively, a single button can be provided, and the number of consecutive presses of the button operates the detector.

In a manual detector, variable input means is provided so that when the detector is placed in a drink, the user can control the input means to set the baseline conductivity manually. In such a manual detector, the variable input means controls a variable resistor or potentiometer to set the baseline resistance or potential, which corresponds to the baseline conductivity of the drink. Further details on the operation of such manual setting are described below in greater detail with reference to FIG. 5.

There are a plurality of ways in which the baseline can be input to the storage means 16. As described above, the baseline can be measured in situ and stored in analogue form, as a resistance or other parameter. The baseline may be measured and converted to digital form, and stored in a memory, such as a RAM. If the predetermined conductivity of a type of drink, such as red wine, or a brand of drink, such as Bacardi Breezer® Lime, is known then the conductivity can be input to storage means 16 without measurement of a drink in situ. The input means may comprise means for receiving such predetermined conductivities from a remote processing unit, whether this is by wireless connection to a mobile phone or by cabled connection to a computer. Such remote connection would allow the user to download such predetermined conductivities and other related or brand information to the detector. Baseline conductivities can be programmed into a ROM or other permanent or semi-permanent memory, for instance, in the form of a look-up table, when the detector is manufactured.

Since the conductivity of a type or brand of drink may vary from batch to batch or from location to location, the user may prefer to measure the baseline in situ for greater accuracy, or for confirmation of predetermined baselines.

Once the baseline conductivity has been stored in storage means 16, the detector 15 can be used to test the drink for spiking with chemical impurities. If a consumer is drinking a number of the same type or brand of drink over the course of an evening then it would be possible to set the baseline conductivity at the beginning of an evening with the first drink and then carry out testing on all subsequent drinks, although it is preferable for accuracy that each drink obtained is tested individually.

For security, the detector may comprise means for locking the baseline in storage means 16 to stop tampering with the detector if it is left unattended. Such locking means may require the user to input a code before the storage means will change the baseline. The locking means may in addition or alternatively be operable to lock all or any other functionality of the detector 15.

In order to test a drink for spiking, the user provides an input to input means 14 to indicate that the user wishes to test a drink for spiking. The probe is inserted into the drink, the conductivity of the drink is tested and the result stored in storage means 18 of the processing means 13. The processing means 13 further comprises comparator means 20 for comparing the baseline conductivity with the test conductivity. If a change in conductivity exceeds a predetermined limit value in the event that the liquid is determined to include a said chemical impurity, the processor means 13 operates an indicator comprising a red LED 24. If the change in conductivity is less than the predetermined limit value, a safe indication is provided by a green LED 26. Although two LEDs are shown in FIG. 1 for providing a warning to the consumer, the warning may be provided in any suitable form, for instance by vibration or sound. The indicator may be a display such as an LCD or multiple LEDs for indicating more information than just a pass or fail condition, for instance if only minor contamination has occurred. Such indication can provide more detailed information concerning the extent of spiking advising the user. An analogue display such as a moving coil meter or moving magnetic meter could be used.

The limit value store 22 is preferably pre-set with a value selected so that relatively minor changes of drink conductivity due to ambient variations do not initiate a warning, but also so that any change in conductivity beyond a relatively minor change and likely due to drink spiking initiates a warning.

The probe 17 comprises means for measuring a variable characteristic of the liquid which is responsive to ambient conditions and the processing means 13 comprises means for compensating for a change in conductivity resulting from a change in said variable characteristic.

In FIG. 1, the variable characteristic is temperature and a temperature compensator 28 compensates for changes in conductivity due to an increase or decrease in temperature. As shown in the table above, the relationship between temperature and conductivity is approximately linear and measurement can be compensated over the relevant temperature range on a linear basis.

Specific details have been provided herein on the response of a drink to contamination with GHB. The detector of FIG. 1 is additionally capable of detecting the contamination of drinks with other chemical impurities, such as Ketamine. Any chemical impurity which provides a response to the application of an electric field at the probe and when added to a drink provides a change in response fall within scope of the invention.

The dosage amount of benzodiazepines for inducing a detrimental pharmacological effect and relatively small and therefore the introduction of benzodiazepines to a drink produces little discernable effect on conductivity. Measure of such conductivity is considered not be practical. If required, a semipermeable sleeve can be provided on the probe for receiving a testing strip suitable for detecting benzodiazepines or other chemical impurities when the probe is inserted in a drink.

Different chemical impurities may provide differing changes in conductivity when added to a drink. Further, different drinks have different baseline conductivities. Accordingly, the detector can be programmed to detect for different impurities in different drinks using appropriate sensitivity and ranging.

The detector of FIG. 1 is specifically adapted to be sensitive to changes of conductivity in the range from typical baseline conductivities of drinks to the conductivities of drinks spiked with chemical impurities.

In another arrangement, the detector comprises a probe insertable into a consumable; processing means coupled to the probe; and an indicator coupled to the processing means; wherein the processing means is configured to receive a signal from the probe and compare said received signal with a stored reference to determine whether the consumable into which said probe is inserted includes a chemical impurity, the processor being configured to operate said indicator in the event that the consumable is determined to include a said chemical impurity, and wherein the stored reference is a baseline which is measured in situ by measurement of a said response when the consumable does not include a chemical impurity.

Referring to FIGS. 2, 3a and 3b, the detector comprises a detector body for housing the components of the detector. In order to permit the user, or consumer, of a drink to use the detector unobtrusively it is preferable that the detector body has a shape similar to a commonly used item, such as a cocktail stirrer, spoon or straw, or other item that not does not appear out of place in a glass or bottle. However, whilst such an arrangement is preferable the detector is not restricted in appearance and may take any suitable form. As shown in FIG. 2, the detector body comprises a drinks umbrella having a stem 4 in which electrodes 5 and 6 are housed and which form part of the conductivity measuring means 12. Electrodes 5 and 6 are electrically conducting metallic plates. The material of the plates is preferably selected such that it readily conducts electricity but does not contaminate the drink over the period in which the detector is placed in the drink. When the detector is activated the electrodes are provided with a potential difference such that an electrical current is passed through the liquid of the drink from one electrode to the other electrode.

The stem may be lengthwise extendable so that it can be adapted to position the electrodes towards the bottom of any one of a plurality of drink vessels of different sizes. In this regard, the stem may have a telescoping mechanism which is sufficiently sealed to prevent the ingress of liquid into the detector.

The umbrella section 1 is a moulded electronics housing comprising a red LED 2 which acts as a warning indicator and a green LED 3 which shows the device is turned on. An IC controller 10 comprises the control for the conductivity measuring means 12, storage means 16 and 18, comparator means 20 and limit value store 22. The detector further comprises an embedded power supply in the form of a watch battery 7 and an on/off switch 8. The battery may be rechargeable and the detector may comprise a connection for connecting the rechargeable battery to a source of electric power.

It is preferable that the detector body has means by which the detector can be associated with an owner of the detector, or personalised so that the owner can readily identify if the detector has been switched with another detector. Such means for personalising the detector may, for instance, take the form of input means for receiving a personal pin code or colour coding.

When DC current is passed through an ionic liquid, the anions are attracted to the more positive electrode and the cations are attracted to the more negative electrode. It is preferable to avoid polarisation, charge-masking and degradation of the electrode materials. An AC arrangement is therefore preferred and is described in more detail with reference to FIG. 5.

For explanatory purposes, a DC control circuit is shown in FIG. 4. When switch 8 is closed, the green LED 3 is on but the circuit containing the red LED 2 is not completed unless a sufficient current flows through the drink between electrodes 5 and 6. The integrated chip 10 is set with a baseline or threshold value based on the unadulterated drink. There can be a temperature compensatory mechanism (not shown) which measures the temperature of the drink and automatically compensates for temperature changes.

In use, the switch 8 is closed by the user turning the green LED 3 on. The stem 4 is then placed in a drink. A baseline current flows between the electrodes 5 and 6 and the measured baseline conductivity is stored by IC 10. If GHB is added to the drink the conductivity of the drink increases thereby increasing the current from the battery 7 which flows between the electrodes. If the increase in conductivity is above a threshold value, the IC 10 completes the circuit and the red LED 2 is turned on and starts to flash alerting the drinker that the drink has been spiked. The detector can be periodically inserted in the drink for testing or alternatively the stem 4 can be left in a drink so that it will warn if a drug is added to the drink.

FIG. 5 is a flow diagram showing a preferred electronic circuit 30 of the detector. Probe 17 and processing means 13 are shown in broken lines. In the circuit shown in FIG. 5, a wheatstone bridge 32 is used as part of circuitry for measuring the conductivity and change in conductivity of a drink. Other sensitive measurement arrangements will be apparent to those skilled in the art, such as a galvanometer. The purpose of the measurement arrangement is to measure the resistance or conductivity of the drink between two electrically conductive probes 34, or electrodes, which are housed in the probe and inserted in the drink for testing. Such arrangements can measure the current flow through the drink or the potential difference across the probes.

The wheatstone bridge comprises four resistors. The resistance VR1 between the probes 34 constitutes one resistor of the bridge. A second resistor R2 is in series with VR1 and is of fixed resistance. A point on the circuit between VR1 and R2 is “A”. A variable resistor VR2 constitutes a third resistor and is in series with resistor R4 which is of fixed resistance. A point on the circuit between VR2 and R4 is “B”. When VR1/R2 is equal to VR2/R4 the potential at A is equal to the potential at B. If the conductivity of a drink increases, resistance VR1 decreases creating a potential imbalance between A and B. The potential difference between A and B corresponds to the change in conductivity of the drink.

In one arrangement of the electronic circuit, the detector is adjusted manually by the user. In this manual arrangement, the probes 34 are placed in an unadulterated drink by the user. The resistance of VR2 is adjusted manually by turning a dial or other such variable input device on the detector so that VR2 has the same resistance as VR1. The dial is turned until the potential at A is equal to the potential at B. When there is an equi-potenial at A and B the user is prompted to stop turning, for instance by flashing the green LED 35, and the resistance VR2 is locked or stored. Such a manual method sets the baseline conductivity of an unadulterated drink. If the detector is used subsequently to measure a drink which has been spiked, any increase in conductivity of the drink due to the presence of chemical impurities results in a decrease in the resistance of VR1. Such a decrease in resistance results in a potential difference between A and B which corresponds to the increased conductivity of the drink and hence the quantity of chemical impurity added.

In an automatic arrangement of the electronic circuit, the resistance of VR2 is controlled automatically by suitable components when setting the baseline conductivity of a drink. In this regard, the current flow in the probe can be detected by either a single resistor or bridge method, as described in detail herein, or by any other suitable means. The measured potential difference is input to an analogue to digital converter and then stored in a storage means for subsequent comparison.

A thermistor 36 compensates for changes in drink temperature after serving. Although different temperature compensating arrangements will suggest themselves to the person skilled in the art, in one such arrangement, the thermistor 36 replaces resistor R2 in wheatstone bridge 32 and hence compensates for temperature by adjustment of the potential at point A.

As indicated above, it is undesirable to pass a DC current through a drink since it could result in deposits on the electrodes. As shown in FIG. 5, a bi-polar bridge energisation means 38 provides pulsed AC current at the two probes 34. A pulse of approximately 0.03 seconds in duration is passed in a first direction and then a pulse of the same duration is passed in an opposite direction. Clock circuitry 40 controls the duration of the pulses. Such a method of pulsing current in opposing directions avoids polarisation of the probes and therefore depositing, conserves battery power and provides synchronised pulses for phase detection of any bridge imbalance. The duration of the pulses is selected by the manufacturer with these factors in mind.

The measured potential difference between points A and B is input to comparator 42 which outputs a high or low signal according to the potential difference.

The comparator signal is input to a phase detector 44 which also receives an output from the clock 40 and accordingly compares the phase of the pulsed AC current.

Suitable logic circuitry controls operation of LEDs 48 and 50 such that the red LED is turned on if an increase in conductivity is detected.

Operation of the control circuit in FIG. 5 is described in more detail with reference to FIG. 6. Clock 40 and bridge energisation means 38 cause an alternating current to pass through the bridge 32. In the absence of spiking (i.e. when conductivity of the drink is at baseline), the alternating current causes the output from the comparator 42 to alternate between high and low as shown at 52. The clock 40 outputs pulses 01 and 02 as shown at 54. Conductivity is measured by the detector at pulse 01 and 02 thereby conserving energy between pulses. If a drink is spiked, the output from the comparator 42 is forced low, and a conductivity measurement at pulse 01 causes logic circuitry 46 to flash red LED 50 indicating that the drink is spiked. If the baseline conductivity has not been adjusted correctly the output from the comparator is forced low as shown at 58 during pulse 02 which causes the logic circuitry 46 to prevent the green LED 48 from flashing indicating to the user that further manual adjustment of the baseline conductivity is required. As shown at 58, the logic circuitry 46 further comprises means which show that the baseline is set correctly by causing the green LED 48 to flash unless it is detected that the drink is spiked or the baseline is not adjusted correctly.

Embodiments of the present invention have been described which measure the affect on conductivity of adding a chemical impurity to a drink. It will be appreciated however that the measurement of the changes in further properties of a drink when chemical impurities are added fall within the scope of the present invention. In particular, the pH of a drink can be measured. The formation of hydrogen ions when for instance GHB is added to a drink can be measured according to a change in pH of the drink.

The pH of a drink can be measured by known electrical techniques such as a pH glass electrode. In particular, an ISFET, which is an ion-sensitive field effect transistor can be used.

It will be seen that embodiments of the invention utilise a more accurate method of measuring a drink for the addition of chemical impurities since, in one arrangement, a baseline measurement of a characteristic of a drink can be taken in situ. The embodiments are adapted so that more than one reading of such a characteristic can be taken and therefore a subsequent measurement of a drink can be taken and compared with the initial baseline reading. Accordingly, if the value of such a characteristic has changed by more than a threshold value, a determination can be made that a drink has been spiked with a chemical impurity.

Additionally, embodiments of the invention take into account the change in a variable characteristic of a drink as a result of ambient conditions and compensate for the effect of such conditions. For instance, temperature increases conductivity and therefore embodiments of the invention compensate for changes in conductivity due to temperature change.

1. A detector for enabling a consumer to test in real time whether a beverage has been spiked with a chemical impurity, the detector comprising:
a probe insertable into a beverage for the measurement of a property of the beverage;
a processor coupled to the probe;
an indicator coupled to the processor;
storage coupled to the processor for storing a baseline measurement of a property of the beverage;
an input device operable by a consumer to indicate to the processor a baseline measurement of a property of the beverage is to be taken, the processor being responsive to said input device to receive a signal from the probe and to store said signal in said storage as a baseline measurement of the property of the beverage; and
a lock operable, once the baseline measurement has been stored in the storage, to lock the baseline measurement in the storage to prevent tampering;
wherein the input device is further operable by a consumer to indicate to the processor that a measurement of the property of the beverage is to be taken for testing, the processor being responsive to said input device to receive a signal from the probe and compare said received signal with a the baseline measurement stored in said storage to test whether a beverage into which said probe is inserted includes a chemical impurity, the processor being configured to operate said indicator in the event that said beverage is determined to include a said chemical impurity.

2. A detector as claimed in claim 1, wherein the probe is selectively connectable to a source of electric potential such that a response of said beverage can be measured when the probe is connected to said source and said signal output from said probe corresponds to said response.

3. A detector as claimed in claim 2, wherein when the probe is connected to said source an electric field is applied to said beverage and said probe is configured to measure the response of said liquid to said field.

4. A detector as claimed in claim 1, wherein the stored baseline measurement corresponds to a response of said beverage when said beverage does not include a chemical impurity and said processor determines that said beverage includes a said chemical impurity when a change in said response from said baseline exceeds a threshold.

5-8. (canceled)

9. A detector as claimed in claim 1, wherein the probe is configured to measure a conductivity of the beverage.

10. A detector as in claim 1, wherein the probe is configured to measure a pH of the beverage.

11. A detector as claimed in claim 1, wherein the probe comprises two electrodes and in use an electrical potential is applied therebetween for measuring the resistance of the beverage between the electrodes.

12. A detector as claimed in claim 1, comprising a detector housing that is configured to resemble an item normally inserted into a drink.

13. A detector as claimed in claim 1, wherein the probe comprises a system for measuring a variable characteristic of the liquid which is responsive to ambient conditions and the processor comprises a compensator for compensating for a change in said received signal resulting from a change in said variable characteristic.

14. A detector as claimed in claim 13, wherein said variable characteristic is temperature.

15. A method of testing in real time whether a beverage has been spiked with a chemical impurity, the method comprising:
inserting, at or shortly after the point of sale, a probe of a detector into a beverage for the measurement of a property of the beverage;
operating the detector to cause a processor that is coupled to the probe to receive a signal from the probe and to store said signal in storage of said detector as a baseline measurement of the property of the beverage;
inserting, at a later point in time, the probe of the detector into the beverage for re-measurement of the property of the beverage for testing; and
operating the detector to cause the processor to receive a signal from the probe, the processor being configured to compare said received signal with the baseline measurement stored in said storage to test whether the beverage into which said probe is inserted includes a chemical impurity, and to operate an indicator in the event that said beverage is determined to include a said chemical impurity.

16. A method as claimed in claim 15, comprising applying an electric field to said liquid and measuring the response of said beverage to said field.

17. A method as claimed in claim 16, wherein the baseline measurement corresponds to a said response of said beverage when said beverage does not include a chemical impurity and the method comprises determining whether a beverage into which said probe is inserted includes a chemical impurity by determining whether a change in said response from said baseline exceeds a threshold.

18-21. (canceled)

22. A detector as claimed in claim 15, comprising measuring a response by measurement of the conductivity of the beverage or the pH of the beverage.

23-25. (canceled)

26. A detector as claimed in claim 1, wherein the chemical impurity is GHB or a chemical analogue of GHB which is converted to GHB in the body.

27. A method as claimed in claim 15, wherein the chemical impurity is GHB or a chemical analogue of GHB which is converted to GHB in the body.
